(19) United States
(12) Patent Application Publication
(10) Pub. No.: US 2024/0202280 A1
(43) Pub. Date: Jun. 20, 2024

(54) LINEAR-PROGRAMMING-BASED RECOMMENDER WITH PERSONALIZED DIVERSITY CONSTRAINTS

(71) Applicant: Microsoft Technology Licensing, LLC, Redmond, WA (US)

(72) Inventors: Miao CHENG, Sunnyvale, CA (US); Kinjal Basu, Stanford, CA (US); Aman Gupta, San Jose, CA (US); Sathiya K. Selvaraj, Sunnyvale, CA (US); Rahul Mazumder, Sommerville, MA (US); Haichao Wei, Santa Clara, CA (US); Haoyue Wang, Cambridge, MA (US)

(21) Appl. No.: 18/076,699

(22) Filed: Dec. 7, 2022

(51) Int. Cl. G06F 18/2113; G06F 18/22; G06N 3/02

(52) U.S. Cl. CPC G06F 18/2113; G06F 18/22; G06N 3/02

(57) ABSTRACT

In an example embodiment, a structured linear program is provided that is usable in recommender models. This structured linear program is able to produce real-time results for a structured recommendation problem with diversity constraints, even for large data sets. The structured linear program operates by first reducing a two-sided diversity constraint to a one-sided diversity constraint, and then introducing a dual variable for a constraint, in order to define a dual objective function. The dual objective function is then solved using a bisection method. A primal solution is then recovered using the solved dual objective function. The resultant primal solution reflects a set of recommended content items that satisfy the diversity constraint, as computed in real-time.

### TECHNICAL FIELD

The present disclosure generally relates to technical problems encountered in machine learning. More specifically, the present disclosure relates to a linear programming-based recommender with diversity constraints.

### BACKGROUND

The rise of the internet has occasioned two disparate yet related phenomena: the increase in the presence of online networks, such as social networking services, with their corresponding user profiles visible to large numbers of people, and the increase in the use of these online networking services to provide content. An example of such content is user profiles. Here, user profiles may include various attributes of a user, as input by that user. In the professional context, these user profiles are often used by users to provide viewers with their career qualifications (e.g., experience, education, etc.), essentially acting like online resumes.

Recommender models can be used in this, and other contexts, to recommend to viewers certain content. In the case of user profiles, a hiring coordinator at an organization or a recruiter can search for user profiles of users whose qualifications match job openings. In some instances, a recommender can actively recommend particular users to such hiring coordinators/recruiters based on a machine learning model's prediction of how well the user's qualifications match the qualifications needed for the job opening.

Recommender models can also be used to recommend other types of content, such as videos on a video sharing or social networking service, music on a streaming music site, books, or toys on a retail site, etc.

In some instances, the set of potential content items to recommend may not be established until runtime. For example, a viewer may input a specific term or phrase in a search box, and only those content items that have attributes matching that specific term or phrase are considered for recommendation. Recommender models can be quite complex, and thus it can be technically challenging to have them be able to produce recommendations in real-time. This is especially true if one or more diversity constraints are placed on the recommendations. A diversity constraint is a constraint that is used to achieve more diversity in a data set. Diversity is the amount of variation there is in values of a particular attribute throughout the data set, although in some instances diversity can also indicate the amount of variation there is in the pieces of data that are presented in a way that makes them likeliest to be selected (e.g., highest ranked). Such diversity constraints are often used to prevent having recommended sets that are too homogeneous. Diversity is desired in many contexts, whether it be diversity of people recommended for job openings or diversity of videos recommended for viewing. Adding such diversity constraints to a recommender model, however, make it difficult for the recommender model to produce results in real-time, due to the added complexity of the computations. One solution would be to create a model that performs initial scoring of all content items in a system against all (or at least many) possible searches in an offline mode, but this can be processing-intensive and may not work in all cases.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiments.

FIG. 3 is a flow diagram illustrating a method, in accordance with an example embodiment.

FIG. 4 is a block diagram illustrating a software architecture, which can be installed on any one or more of the devices described above.

FIG. 5 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a structured linear program is provided that is usable in real-time recommender models for large data sets. This structured linear program is able to produce real-time results for a structured recommendation problem with diversity constraints, even for large data sets. The structured linear program operates by first reducing a two-sided diversity constraint to a one-sided diversity constraint, and then introducing a dual variable for a constraint, in order to define a dual objective function. The dual objective function is then solved using a bisection method. A primal solution is then recovered using the solved dual objective function. The resultant primal solution reflects a set of recommended content items that satisfy the diversity constraint, as computed in real-time (e.g., fast enough so that the solution can be computed in response to input from a user without the user noticing any delay, such less than a 20 ms delay).

The duality principle is the principle that optimization problems may be viewed from either of two perspectives: the primal problem or the dual problem. If the primal problem is a minimization problem, for example, then the dual problem is a maximization problem (and vice-versa). Thus, by turning the primal problem into its dual problem and solving it using the aforementioned techniques, the structured linear program is then able to obtain a result set to the primal problem without the inefficient calculations required to directly solve the primal problem.

In a further example embodiment, when the candidate set is large, a screening technique is used to quickly detect and discard candidates that will not be in the optimal solution. This reduces the overall size of the candidate set that needs to be handled by the recommender.

### Description

Linear programs arise in several applications across various scientific and industrial disciplines. Examples include scheduling, matching entities, network flow, recommender systems, and many others. Despite the significant development of linear programming solvers, modern applications bring new challenges in solving linear programming problems, either due to extreme scale datasets, or due to strict restrictions on time budget (e.g., in an online setting where the linear program needs to be solved in real-time).

Consider a social media platform that makes personalized recommendations for its users. Suppose there are m candidates (which could be items or people for generating recommendations for user u; each candidate i has a utility score cᵢ∈ [symbol] that is generated by a machine learning model, representing the probability that u may interact with this candidate. Suppose there are n slots to present the recommendations, with weight wⱼ>0 representing the importance of the slot j. In particular, assume w₁>w₂> . . . >wₙ, i.e., slots in the ‘front’ (or higher ranked), are more important than slots in the ‘rear’ (or lower ranked). One may also assume that n is much smaller than m, for example, n is in the range of 10 to 20, while m can be in the range from hundreds to thousands. The recommendations and scores are specific to the user u and vary across users.

One goal of the system is to find an assignment of the candidates into the slots so as to maximize the utility score. A linear programming problem can be defined per user u, and the linear programming problems can be solved for many users in parallel. Let matrix X^{u}∈ [symbol] ^{m×n} represent a randomized assignment for each user u's recommendations, where each Xᵢⱼ^{u}∈[0,1] stands for the probability that candidate i is assigned to slot j. For simplicity, the superscript of u is removed in all the following notations. Then for each user u, the recommendation problem can be formulated as:

$${max}_{X ∈ {ℝ}^{m \times n}} {c}^{T} Xw s . t . X ∈ {S}_{m , n}$$

where c=(c₁, c₂, . . . , cₘ)^{T}∈ [symbol] ^{m}, w=(w₁, w₂, . . . , wₘ)^{T}∈ [symbol] ⁿ, and the set S_{m,n} is defined by

S_{m,n}:={X∈ [symbol] ^{m×n}|X1ₙ≤1ₘ,1ₘ^{T}X=1ₙ^{T},X≥0}

where 1ₖ is the vector in [symbol] ^{k} with all coordinates being 1 (for any k≥1). The constraint X1ₙ≤1ₘ imposes that for each candidate i, the probability that i is assigned to some slot is at most 1. The constraint 1ₘ^{T}X=1ₙ^{T} implies that each slot must be assigned a candidate. Note that

$${max}_{X ∈ {ℝ}^{m \times n}} {c}^{T} Xw s . t . X ∈ {S}_{m , n}$$

has a simple closed-form solution: let σ* be a permutation on [m] such that c_{σ*(1)}≥c_{σ*(2)}≥ . . . ≥c_{σ*(m)}, then matrix X* with X_{σ*(j),j}*=1 for all j∈[n] and all other entries being 0, is an optimal solution. In other words, the candidates with the top n scores are placed in the top n slots, in descending order of their score.

In the system described above, only utility scores are used to make assignments. Recommendations obtained this way often lead to selection bias and can favor a particular group in terms of the overall ranking. In other words, the recommendations often will present more results having a certain value for a particular attribute (and/or rank such results higher) than results with a different value for that attribute. For example, different kinds of people, different activity levels across the platform, different types of content, etc., may get a very different exposure or placement in the rankings due to bias creeping into the system. Average ranks of one group may be much higher than those of another group when the system is solely optimized for overall utility which increases homogeneity over time.

To diversify the recommendations across multiple groups, in an example embodiment an additional diversity constraint is introduced to this problem. The diversity constraint acts as a limit on recommendations made by a recommender model to help ensure diversity of the output recommendations. Let aᵢ∈ [symbol] denote the feature in which diversity is desired, of the candidate, i. The following linear program restricts the range of the weighted summation of the diversity features:

$${max}_{X ∈ {ℝ}^{m \times n}} {c}^{T} Xw s . t . X ∈ {S}_{m , n} , {b}_{1} \leq {a}^{T} Xw \leq {b}_{2}$$

where a=(a₁, a₂, . . . , aₘ)^{T}∈ [symbol] ^{m}, and b₁ and b₂ are chosen lower and upper bounds on the total weighted diversity. This allows any diversity restriction to be injected with appropriate choices on a, b₁ and b₂. For example, the constraint can be the impression gap between certain groups of people from different industries, or exposure gap between different genres of content.

### Unlike

$${max}_{X ∈ {ℝ}^{m \times n}} {c}^{T} Xw s . t . X ∈ {S}_{m , n}$$

however, the linear programming problem in

$${max}_{X ∈ {ℝ}^{m \times n}} {c}^{T} Xw s . t . X ∈ {S}_{m , n} , {b}_{1} \leq {a}^{T} Xw \leq {b}_{2}$$

does not have a closed-form solution. While some prior art solvers can solve the problem in roughly 20 milli-seconds (on an example with m=100, n=10), this is not fast enough for online applications. For an online application where data cᵢ (and the set of candidates themselves) are frequently updated, the personalized linear programming problem needs to be solved in an “on-click” manner. When a user clicks a button to load the recommendations, the linear programming problem under the hood needs to be solved in an instant, ideally within 3˜5 milli-seconds.

In an example embodiment, a specialized algorithm is provided, to solve such a linear programming problem with a diversity constraint, fast enough for online processing. More particularly, a method is used that introduces a dual variable for the diversity constraint and solves the one-dimensional dual problem using a bisection method; when the iteration is “close enough” to the optimal dual solution, the piece-wise linear structure of the dual objective function is traced to locate the exact value of the dual optimal solution. The bisection method described herein identifies when the iteration is “close enough.” The primal optimal solution can then be recovered from the dual optimal solution. A screening technique is also introduced that can detect and drop candidates that will not be assigned to any slots in the optimal solution. This screening technique can significantly speed up the recommender model's performance when the number of candidates m is large.

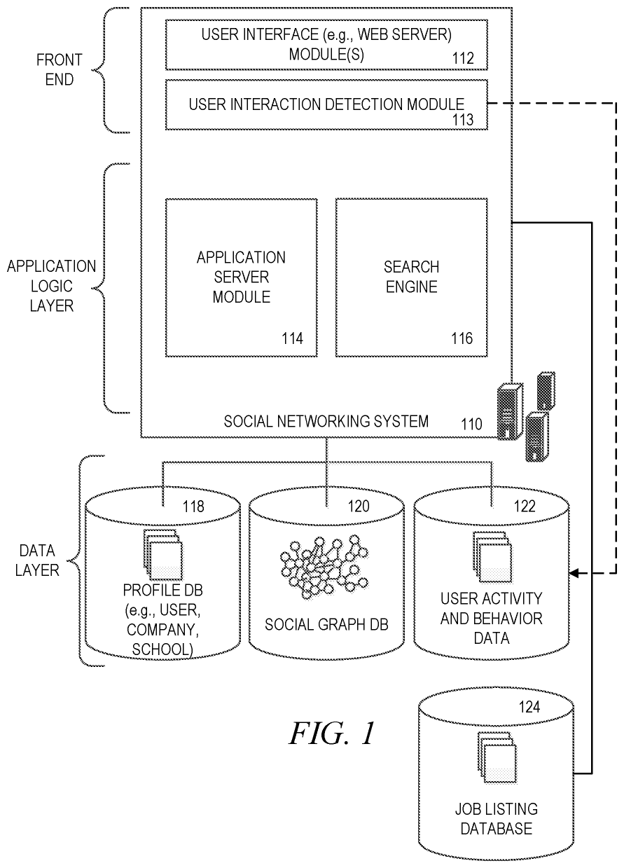

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based API requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118, or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users' interactions and behavior (e.g., content viewed, links or buttons selected, messages responded to, etc.) may be tracked, and information concerning the users' activities and behavior may be logged or stored, for example, as indicated in FIG. 1, by the user activity and behavior database 122. This logged activity information may then be used by the search engine 116 to determine search results for a search query.

Although not shown, in some embodiments, the social networking system 110 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

As described above, example embodiments may be utilized for ranking and/or selection of user profiles, from the profile database 118. In some example embodiments, this ranking and/or selection may at least be partially based on attributes of, or related to, a viewer. In other words, the recommender may recommend one or more user profiles to a viewer, at least partially based on attributes of the viewer themselves, or at least some attributes related to the viewer (such as attributes of a job listing posted by the viewer, which may be stored in a job listing database 124.)

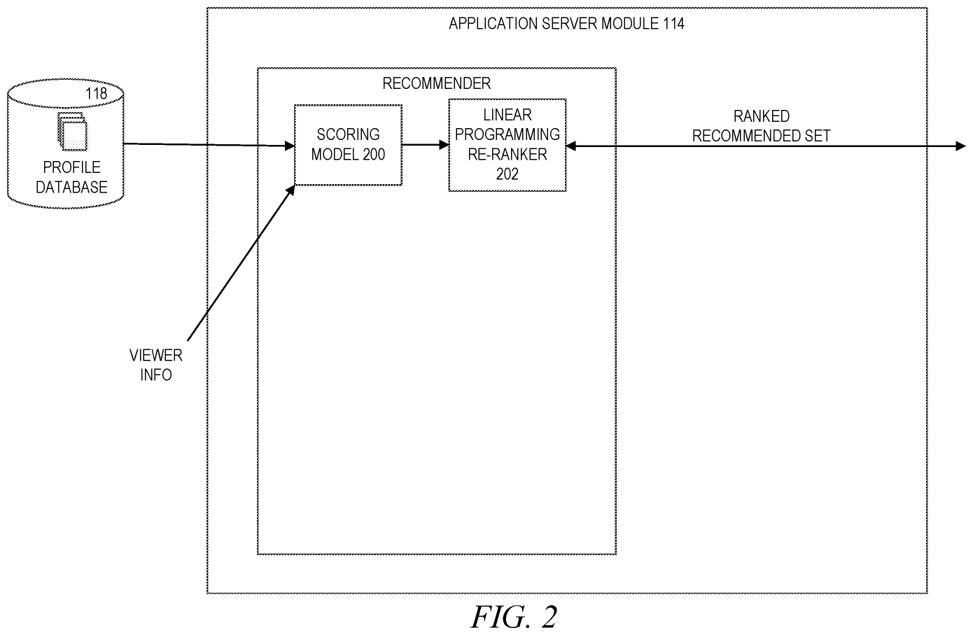

FIG. 2 is a block diagram illustrating the application server module 114 of FIG. 1 in more detail, in accordance with an example embodiment. While in many embodiments, the application server module 114 will contain many subcomponents used to perform various actions within the social networking system 110, in FIG. 2 only those components that are relevant to the present disclosure are depicted.

A scoring model 200 may obtain user profiles from profile database 118, as well as viewer information regarding a viewer. A viewer is a user who will be presented with recommended user profiles. Examples of viewers may include, but are not limited to, hiring coordinators and recruiters.

In an example embodiment, the scoring model 200 implements a relevance model that calculates a relevance score for each input user profile, the relevance score indicative of the relevance of the user profile to the viewer. In some example embodiments, this scoring model 200 may be a machine-learned model that is trained by a machine learning algorithm. The training may include using training data, such as labeled pieces of content, to learn one or more weights assigned to each of one or more features, such as user features, content features, and channel features. In an example embodiment, the machine learning algorithm may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method.

In some example embodiments, the scoring model 200 may be retrained based on feedback received from viewers. For example, if the scoring model 200 recommends content D to a viewer and the viewer ignores the recommendation, or even negatively “marks” the content (such as by explicitly selecting a “dismiss” button displayed next to the recommendation), then this information may be fed back into the machine learning algorithm to improve the training set to retrain the machine-learned model.

Furthermore, the term “relevance” in this context means how likely the viewer is to take an action when the corresponding recommended content is presented to the viewer. In the case of user profiles, such an action may be, for example, reaching out to the user corresponding to the user profile (such as via email, text, phone, etc.) to inquire as to whether the user would be interested in applying for a particular job. In other environments, relevance can be based on a different potential action. In particular, the meaning of the term “relevance” to a particular machine learned model is based on labels fed to the machine learned model during training. In other words, the labels themselves define what relevance means in a particular environment, and it is not necessary to have another attached meaning to the term. If the labels indicate that content A is relevant to user Y, then if content B is similar to content A, then the model will learn that content B is also likely to be relevant to user Y, regardless of the reasons why content A is relevant to user Y.

The output of the scoring model 200 is a set of scored user profiles. These scored user profiles are then fed to a linear programming re-ranker 202. The linear programming re-ranker utilizes a specialized linear programming technique described herein to re-rank the scored user profiles, as well as potentially eliminate some of the scored user profiles from consideration, to ultimately produce a ranked recommended set of user profiles with higher diversity than the original scored user profiles.

As mentioned briefly above, diversity constraint(s) may be added at the re-ranking stage to ensure diversity in the ranked recommended set of user profiles. A diversity constraint is a constraint on the output of the linear programming re-ranker 202 that is provided to ensure that diversity. Diversity constraints can be expressed in a number of different ways. In a simple example, an upper and lower bounds of a percentage of user profiles having a particular attribute may be provided, for example, a constraint that no more than 80% and no fewer than 20% of the user profiles in the ranked recommended set should be for users who reside in California (to ensure geographic diversity). Alternatively, or in conjunction with those upper and lower bounds, weights may be assigned to the positions in a ranking, reflecting the common behavior of viewers to focus first on higher ranked pieces of content than lower ranked pieces of content. Thus, for example, the positions may be weighted to try and ensure that not all the top 10 spots in the ranking are taken by user profiles for users in the same group (e.g., users who reside in California).

Nevertheless, a diversity constraint with an upper and lower bound will, for purposes of the present disclosure, be considered to be a single diversity constraint. The techniques described herein are designed to optimize the reranking process for cases where there is such a single diversity constraint, so that the reranking can be performed in real-time, without any sort of offline processing needed. Indeed, in some example embodiments, the techniques described herein are limited to cases where there is one, and only one, such diversity constraint. In

$${max}_{X ∈ {ℝ}^{m \times n}} {c}^{T} Xw s . t . X ∈ {S}_{m , n} ,$$

b₁≤a^{T}Xw≤b₂, the diversity constraint introduces both lower bound b1 and upper bound b₂ on a^{T}Xw. However, to find the optimal solution, either the lower bound or the upper bound can be dropped, as shown by the following. Define X₀ to be the set of optimal solutions without the diversity constraint, i.e., X₀:=argmax{c^{T}Xw|X∈S_{m,n}}.
(i) If min_{X}_{_{∈}}_{X}_{₀}{a^{T}Xw}>b₂, then the set of optimal solutions is the same as

$${max}_{X ∈ {ℝ}^{m \times n}} {c}^{T} Xw s . t . X ∈ {S}_{m , n} , {a}^{T} Xw \leq {b}_{2} .$$

(ii) If min_{X}_{_{∈}}_{X}_{₀}{a^{T}Xw}<b₁, then the set of optimal solutions is the same as

$${max}_{X ∈ {ℝ}^{m \times n}} {c}^{T} Xw s . t . X ∈ {S}_{m , n} , {a}^{T} Xw \leq {b}_{1} .$$

(iii) If there exists X̅∈X₀ such that b₁≤a^{T}X̅w≤b₂, then X̅ is an optimal solution.

Thus, the problem is solved with no diversity constraints. The solution will satisfy one side of the diversity constraints and violate the other side. Only the side of the diversity constraint that is violated is kept (because the other side is automatically satisfied), hence reducing the problem to a problem with only one-sided diversity constraint.

This provides a procedure to drop one side of the diversity constraint without changing the optimal solution. To use it in practice, X₀ is evaluated, which can be efficiently computed via a ranking of the coordinates of c. When there is no tie in the ranking of the coordinates of c, the optimal set X₀ will only contain one point, X₀={X̅} and redundant constraints are removed.

Note that

$${max}_{X ∈ {ℝ}^{m \times n}} {c}^{T} Xw s . t . X ∈ {S}_{m , n} ,$$

a^{t}Xw≤b₁, can be written in similar form to

$${max}_{X ∈ {ℝ}^{m \times n}} {c}^{T} Xw s . t . X ∈ {S}_{m , n} ,$$

a^{T}Xw≤b₂, with a replaced by −a and b₂ replaced by −b₁. Thus, to solve either of these, a dual variable λ≥0 is introduced for the constraint a^{T}X*w≤b₂, and the dual objective function,

$$g ( λ ) := {max}_{X ∈ {S}_{m , n}} {c}^{T} Xw - λ ( {c}^{T} Xw - {b}_{2} ) = {max}_{X ∈ {S}_{m , n}} {( c - λ a )}^{T} Xw + {b}_{2} λ$$

is defined. Then, g is a piece-wise linear convex function, and the dual problem is

$${min}_{λ \geq 0} g ( λ ) .$$

More particularly, the hard constraint is added into a penalty added to the objective function. This penalty is multiplied by a weight called the dual variable. The penalized problem is much easier to solve than the constrained problem as it has a closed-form solution. From duality theorem, to solve the original problem, it suffices to find the “optimal dual solution” and solve the corresponding penalized problem.

Thus, for each fixed λ≥0, the value g(λ) can be evaluated by solving the maximization in

$$( λ ) := {max}_{X ∈ {S}_{m , n}} {c}^{T} Xw - λ ( {c}^{T} Xw - {b}_{2} ) = {max}_{X ∈ {S}_{m , n}} {( c - λ a )}^{T} Xw + {b}_{2} λ ,$$

which can be computed in closed form via a sorting of the coordinates of c−λa. Let X_{λ} be the set of optimal solution. Then, the extreme points of X_{λ} are given by the following:

ext(X_{λ})={X^{(σ)}|σ is a permutation on [m] with (c−λa)_{σ(1)}≥(c−λa)_{σ(2)}≥ . . . ≥(c−λa)_{σ(n)}}

where X^{(σ)}∈S_{m,n} is the matrix with X_{σ(i),i}=1 for i∈[n] and all other entries being 0. If the top a values of c−λa have no tie, the set ext(X_{λ}) (and also X_{λ}) only contains one element, i.e., there is a unique solution. Once X_{λ} is computed, the derivatives of g can also be evaluated.

For any λ>0, the left derivative and right derivative of g are given by

$${g}_{-}^{′} ( λ ) = {b}_{2} - {max}_{X ∈ {X}_{λ}} \{ {a}^{T} Xw \} , and {g}_{+}^{′} ( λ ) = {b}_{2} - {min}_{X ∈ {X}_{λ}} \{ {a}^{T} Xw \} .$$

Note that g is a piece-wise linear function. For λ in the interior of a linear block, the left and right derivatives are the same: g′_(λ)=g′₊(λ). For λ at the intersection of two linear blocks (called a kink of g), it holds g′_(λ)<g′₊(λ). In particular, if at some λ>0 the top n coordinates of c−λa are unique, then X_{λ} contains only one point, and λ must lie in the interior of a linear block. Furthermore, the top n values of c−λa are the same for all other λ in the interior of the same linear block. This motivates a method to trace the piece-wise linear structure of g via observing the top n coordinates of c−λa as λ changes.

For λ>0, let K_{R}(λ) be the smallest kink of g that is larger than λ, and K_{L}(λ) be the largest kink of g that is smaller than λ. For any vector y∈ [symbol] ^{m}, let [symbol] (y) be the set of top n coordinates of y (including ties), that is,

[symbol]

(y):={i∈[m]|#{j∈[m]|yⱼ<yᵢ}≤n−1}.

For a given λ>0, letting z:=c−λa, then K_{R}(λ) and K_{L}(λ) can be computed in closed form as follows:

$${K}_{R} ( λ ) = λ + {min}_{( i , j )} \{ \frac{{z}_{i} - {z}_{j}}{{a}_{i} - {a}_{j}} \vert j ∈ ( z ) , i ∈ [ m ] , {a}_{i} - {a}_{j} > 0 , {z}_{i} - {z}_{j} > 0 \} \\ {K}_{L} ( λ ) = λ + {min}_{( i , j )} \{ \frac{{z}_{i} - {z}_{j}}{{a}_{j} - {a}_{i}} \vert j ∈ ( z ) , i ∈ [ m ] , {a}_{j} - {a}_{i} > 0 , {z}_{i} - {z}_{j} > 0 \} .$$

As shown above, one can trace the exact value of the kinks of g starting from an arbitrary λ>0. As long as # [symbol] (y)=O(n), the computation cost of K_{R}(λ) and K_{L}(λ) is O(mn) operations.

To find the optimal dual variable, a bisection method is used to iteratively shrink the possible range of the optimal dual variable. Since each bisection step decreases the range by a half, this procedure can quickly locate the dual optimal solution.

Thus, to solve

$${max}_{X ∈ {ℝ}^{m \times n}} {c}^{T} Xw s . t . X ∈ {S}_{m , n} ,$$

a^{T}Xw≤b₂, the one-dimensional dual problem

$${min}_{λ \geq 0} g ( λ )$$

is solved using a bisection method, which maintains and updates an interval [λₘᵢₙ, λₘₐₓ] that contains the dual optimal solution λ*. In each iteration, the algorithm computes the value and derivatives of g at the midpoint λ=(λₘᵢₙ+λₘₐₓ)/2 of this interval; if g′₊(λ)<0, then λ<λ*, and updates the interval to [λ, λₘₐₓ]: if g′_(λ)<0, then λ>λ*, and updates the interval to (λₘᵢₙ, λ); otherwise it holds g′_(λ)≤0≤g′₊(λ), which indicates that λ=λ*.
In the above. the bisection method shrinks the interval by half in each iteration, so the value of the dual optimal solution can be quickly located in a small interval after a few iterations. When the interval is small enough, the algorithm computes a nearby kink following

$${K}_{R} ( λ ) = λ + {min}_{( i , j )} \{ \frac{{z}_{i} - {z}_{j}}{{a}_{i} - {a}_{j}} \vert j ∈ ( z ) , i ∈ [ m ] , {a}_{i} - {a}_{j} > 0 , {z}_{i} - {z}_{j} > 0 \} \\ {K}_{L} ( λ ) = λ + {min}_{( i , j )} \{ \frac{{z}_{i} - {z}_{j}}{{a}_{j} - {a}_{i}} \vert j ∈ ( z ) , i ∈ [ m ] , {a}_{j} - {a}_{i} > 0 , {z}_{i} - {z}_{j} > 0 \} ,$$

and checks if this kink is the exact optimal dual solution (using the signs of left and right derivatives). If the kink is the optimal solution, the algorithm is terminated immediately; otherwise, the bisection iterations continue. The details of the above mentioned algorithm are summarized in pseudocode of Process[1] below.

Note that in this process, the major algebraic operations are conducted in the computations of X_{λ} and K_{L}(λ) (or K_{R}(λ)). In each iteration, to compute X_{λ}, one needs to sort the vector c−λa, which takes m log(m) operations. When λₘₐₓ−λₘᵢₙ Δ, an additional tracing step is needed to compute K_{L}(λ) or K_{R}(λ), which takes O(mn) operations. Therefore, the cost of Process[1] scales (at least) linearly with respect to m, which can get expensive when m is very large. When a recommender model designer or controller determines that this expense is too large (e.g., it uses too many computing resources or takes too long), a method to accelerate the process, as described in more detail later, can be utilized

From duality theory, the primal optimal solution and dual optimal solution satisfy a set of equalities and inequalities known as the Karush-Kuhn-Tucker (KKT) conditions. These are first derivative tests. Once the dual optimal solution is found, the primal optimal solution can be recovered using the KKT condition.

Thus, f Process[1] finds the exact dual optimal solution λ*, the (primal) optimal solution of

$${max}_{X ∈ {ℝ}^{m \times n}} {c}^{T} Xw s . t . X ∈ {S}_{m , n} ,$$

a^{T}Xw≤b₂, can be recovered directly. Note that Process[1] also makes X_{λ*} available. Since λ* is the dual optimal solution, g′_(λ*)≤0 and g′₊(λ*)≥0, implying

$${min}_{X ∈ {X}_{λ *}} \{ {a}^{T} Xw \} \leq {b}_{2} \leq {max}_{X ∈ {X}_{λ *}} \{ {a}^{T} Xw \} .$$

Let X¹ and X² be two extreme points of X_{λ*} such that a^{T}X¹w≤b₂ and a^{T}X²w≥b₂. Define p:=(b₂−a^{T}X²w)/(a^{T}X¹w−a^{T}X²w) and

X*:=pX¹+(1−p)X²,

then X*∈S_{m,n} and a^{T}X*w=b₂. By the KKT condition, X* is an optimal solution of problem.

When the number of candidates m is large, a screening technique may be used in the process of Process[1] which can quickly detect and discard candidates that will not be in the optimal solution, i.e., the corresponding rows of the optimal solution X* are zeros. Note that the candidates that are present in the optimal solution must be the top n coordinates of the vector c−λ*a, where λ* is the dual optimal solution. Although λ* is not available at the beginning, after a few iterations of Process [1], an interval of [λₘᵢₙ, λₘₐₓ] is obtained that can approximately locate the value of λ*. If at some point λ that is close to λ*, some candidate i has a very low rank in the sorting of c−λa (far from being top n), and this is strong evidence that maybe i is also not in the top n of vector c−λ*a. This is described in the following: Let λ* be the solution of

$${min}_{λ \geq 0} g ( λ ) ,$$

and let λₘᵢₙ, λₘₐₓ satisfy λₘᵢₙ≤λ*≤λₘₐₓ. For any i∈[m], if there exist indices i₁, . . . , iₙ∈[m] such that

$$( c - {λ}_{min} a ) , < {min}_{k ∈ [ n ]} \{ {( c - {λ}_{min} a )}_{ik} \} , and {( c - {λ}_{max} a )}_{i} << {min}_{k ∈ [ n ]} \{ {( c - {λ}_{max} a )}_{ik} \}$$

Then the i-th row of the solution is zero.

According to the above, to prove that candidate i∈[m] is not selected in the optimal assignment, it suffices to find a set of “good” indices i₁, . . . , iₙ such that

$$( c - {λ}_{min} a ) , < {min}_{k ∈ [ n ]} \{ {( c - {λ}_{min} a )}_{ik} \} , and {( c - {λ}_{max} a )}_{i} << {min}_{k ∈ [ n ]} \{ {( c - {λ}_{max} a )}_{ik} \}$$

holds true. Different choices of i₁, . . . , iₙ may lead to different quality of screening. When the interval [λₘᵢₙ, λₘₐₓ] is small enough, if one takes i₁, . . . , iₙ to be the top n coordinates of c−λa for some λ∈[λₘᵢₙ, λₘₐₓ], then they may also have a high rank in the sorting of both c−λₘᵢₙa and c−λₘₐₓa, and can be used as good candidates for the screening.

In an example embodiment, a screening step is added in each iteration of Process[1]. In particular, i₁, . . . , iₙ are taken to be the top n coordinates of c−λ̅a for λ=(λₘᵢₙ+λₘₐₓ)/2, and the inequalities are checked for all other i∈[m]. If for some i the inequalities

$$( c - {λ}_{min} a ) , < {min}_{k ∈ [ n ]} \{ {( c - {λ}_{min} a )}_{ik} \} , and {( c - {λ}_{max} a )}_{i} << {min}_{k ∈ [ n ]} \{ {( c - {λ}_{max} a )}_{ik} \}$$

holds true, then i can be discarded, and the dimension of the problem is reduced. The above-mentioned screening idea is formally summarized in Process 2 below.

Process[1] Bisection + tracing

```
Input: Tolerances Δ > δ ≥ 0.
Initially set λₘᵢₙ = 0, λₘₐₓ = ∞ and λ = 1.
while λₘₐₓ − λₘᵢₙ > δ:
  Solve
$g ( λ ) := {max}_{X ϵ {S}_{m , n}} {c}^{T} Xw - λ ( {c}^{T} Xw - {b}_{2} ) = {{max}_{X ϵ {S}_{m , n}} ( c - λ a )}^{T} Xw + {b}_{2} λ and get {X}_{λ} .$
Compute g′₊(λ) and g′₋(λ) using
${g}_{-}^{′} ( λ ) = {b}_{2} - {max}_{X ϵ {X}_{λ}} \{ {a}^{T} Xw \} , and {g}_{+}^{′} ( λ ) = {b}_{2} - {min}_{X ϵ {X}_{λ}} \{ {a}^{T} Xw \} .$
  If g′₊ (λ) > 0:
    If λₘₐₓ − λₘᵢₙ < Δ:
      Compute K_{R}(λ) and g′₊(K_{R}(λ)) and g′₋(K_{R}(λ)).
      If g′₊(K_{R}(λ)) ≤ 0 ≤ g′₋(K_{R}(λ)), break and output λ* = K_{R}(λ).
    If λₘₐₓ < ∞, then set λₘᵢₙ = λ, and λ = (λₘₐₓ + λₘᵢₙ)/2;
    Else, λₘₐₓ = ∞, then set λₘᵢₙ = λ and λ = 2λ.
  If g′₋(λ) < 0 :
  If λₘₐₓ − λₘᵢₙ < Δ:
    Compute K_{L}(λ) and g′₊(K_{L}(λ)) and g′₋(K_{L}(λ)).
    If g′₊(K_{L}(λ)) ≤ 0 ≤ g′₋(K_{L}(λ)), break and output λ* = K_{L}(λ).
      Set λₘₐₓ = λ and λ = (λₘₐₓ + λₘᵢₙ)/2.
  If g′₊(λ) ≤ 0 ≤ g′₋(λ):
    $output λ * = λ as an optimal solution of {min}_{λ \geq 0} g ( λ ) .$
end while
Output The interval [λₘᵢₙ, λₘₐₓ].
```

Process[2] Bisection + tracing + screening

```
Input: Tolerances Δ > δ ≥ 0.
Initially set λₘᵢₙ = 0, λₘₐₓ = ∞ and λ = 1. Set I = [m].
while λₘₐₓ − λₘᵢₙ > δ:
  Solve
$g ( λ ) := {max}_{X ϵ {S}_{m , n}} {c}^{T} Xw - λ ( {c}^{T} Xw - {b}_{2} ) = {{max}_{X ϵ {S}_{m , n}} ( c - λ a )}^{T} Xw + {b}_{2} λ and get {X}_{λ}$
(with I in place of [m]).
    Compute g′₊(λ) and g′₋(λ) using
    ${g}_{-}^{′} ( λ ) = {b}_{2} - {max}_{X ϵ {X}_{λ}} \{ {a}^{T} Xw \} , and {g}_{+}^{′} ( λ ) = {b}_{2} - {min}_{X ϵ {X}_{λ}} \{ {a}^{T} Xw \} .$
  If g′+(λ) > 0:
    If λmax − λmin < Δ:
      Compute K_{R}(λ) and g′₊(K_{R}(λ)) and g′₋(K_{R}(λ))
      (with I in place of [m].
      If g′₊(K_{R}(λ)) ≤ 0 ≤ g′₋(K_{R}(λ)), break and output λ* = K_{R}(λ).
    If λₘₐₓ < ∞, then set λₘᵢₙ = λ, and λ = (λₘₐₓ + λₘᵢₙ)/2;
    Else, λₘₐₓ = ∞, then set λₘᵢₙ = λ and λ = 2λ.
  If g′₋(λ) < 0 :
    If λₘₐₓ − λₘᵢₙ < Δ:
      Compute K_{L}(λ) and g′₊(K_{L}(λ)) and g′₋(K_{L}(λ)).
      (with I in place of [m]
      If g′₊(K_{L}(λ)) ≤ 0 ≤ g′₋(K_{L}(λ)), break and output λ* = K_{L}(λ).
    Set λₘₐₓ = λ and λ = (λₘₐₓ + λₘᵢₙ)/2.
  If g′₊(λ) ≤ 0 ≤ g′₋(λ):
    output λ* = λ as an optimal solution of (7).
  (Screening to shrink I)
  If λₘₐₓ < ∞:
    1. Let i₁, . . . , iₙ be the indices in I corresponding to top n elements
    of (c − λa).
    (Break ties arbitrarily, if any).
    2. Find out
      I_{drop} := {i ∉ I | Inequalities in (14) are satisfied}
    and update I = I\I_{drop}.
end while
Output The interval [λₘᵢₙ, λₘₐₓ].
```

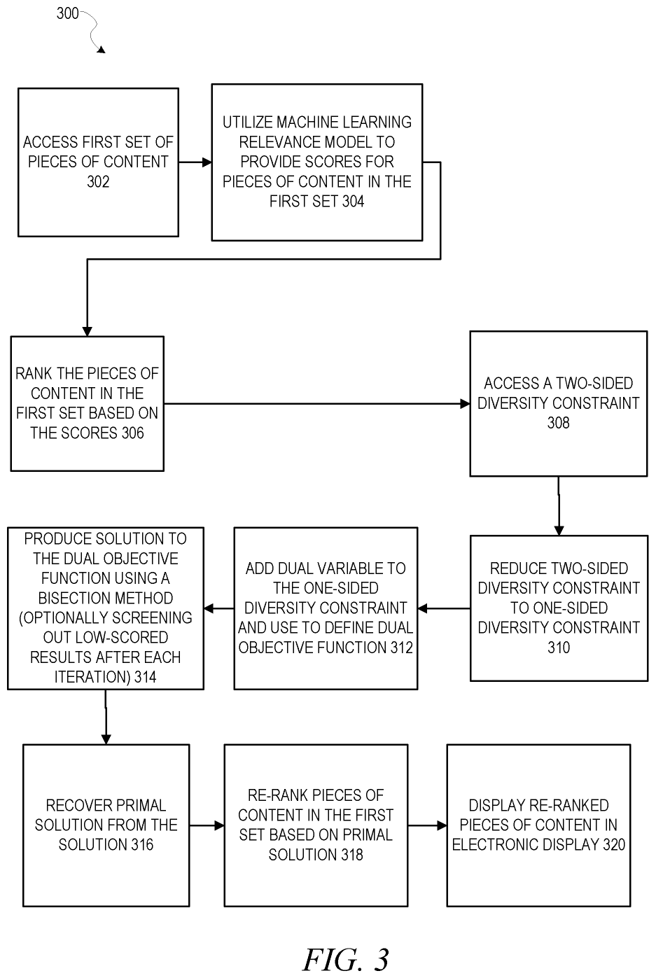

FIG. 3 is a flow diagram illustrating a method 300, in accordance with an example embodiment. At operation 302, a first set of pieces of content is accessed. The pieces of content may be, for example, user profiles or articles in an online network. At operation 304, a machine learning relevance model is utilized to provide scores for pieces of content in the first set of pieces of content. This utilization may include, for example, passing information about each of the pieces of content in the first set as well as information about a viewer into the machine learning relevance model. Each score indicates a relevance of a corresponding piece of content to the viewer, as calculated by the model.

At operation 306, the pieces of content in the first set are ranked based on the scores. At operation 308, a two-sided diversity constraint is accessed. The two-sided diversity constraint has an upper bound and lower bound for pieces of content having a first attribute. At operation 310, the two-sided diversity constraint is reduced to a one-sided diversity constraint by eliminating either the upper bound or the lower bound. In an example embodiment, the machine learning relevance model is run without either bound (i.e., without constraints), and it is determined which of the two bounds is satisfied by the result. The bound that is satisfied is then the one that is eliminated, and the machine learning relevance model is rerun with the bound that was not satisfied as the constraint.

At operation 312, a dual variable is added to the one-sided diversity constraint and the one-sided diversity constraint is used to define a dual objective function. At operation 314, a solution to the dual objective function is produced using a bisection method. The bisection method iterates a plurality of times, maintaining and updating an interval between a minimum value of the dual variable and a maximum value of the dual variable, shrinking the interval by half in each iteration. The iterations are stopped when the interval is smaller than some threshold. Optionally, at each iteration, one or more pieces of content, from the first set of pieces of content that would not be contained in a top n coordinates of a vector containing the solution, are screened out, based on the scores.

At operation 316, a primal solution is recovered from the solution. In some example embodiments, this solution is selected from the interval after at least a predetermined number of iterations, such as three iterations. At operation 318, the pieces of content are re-ranked in the first set based on the primal solution. At operation 320, the re-ranked pieces of content are displayed in an electronic display as recommendations to a user operating a device containing or connected to the electronic display.

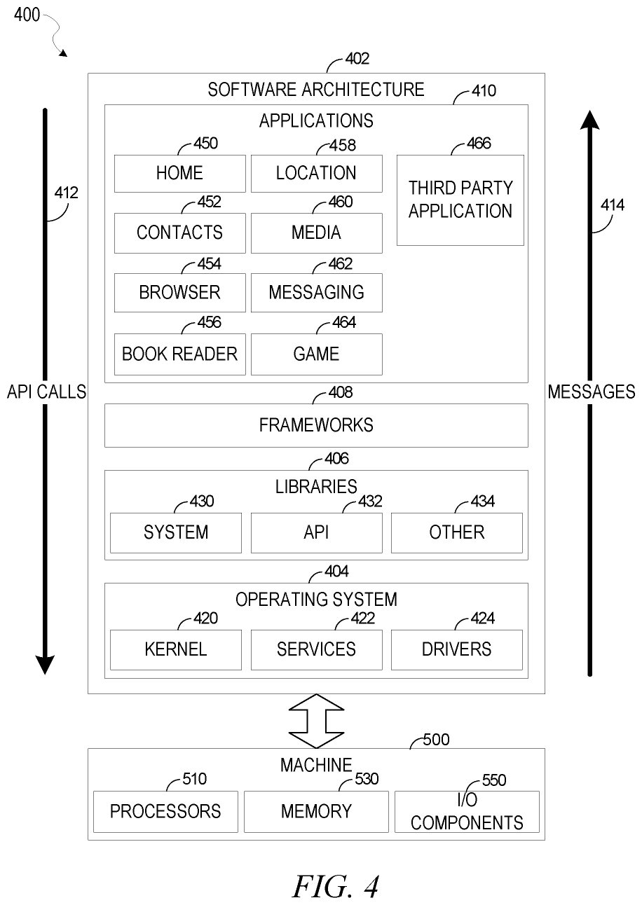

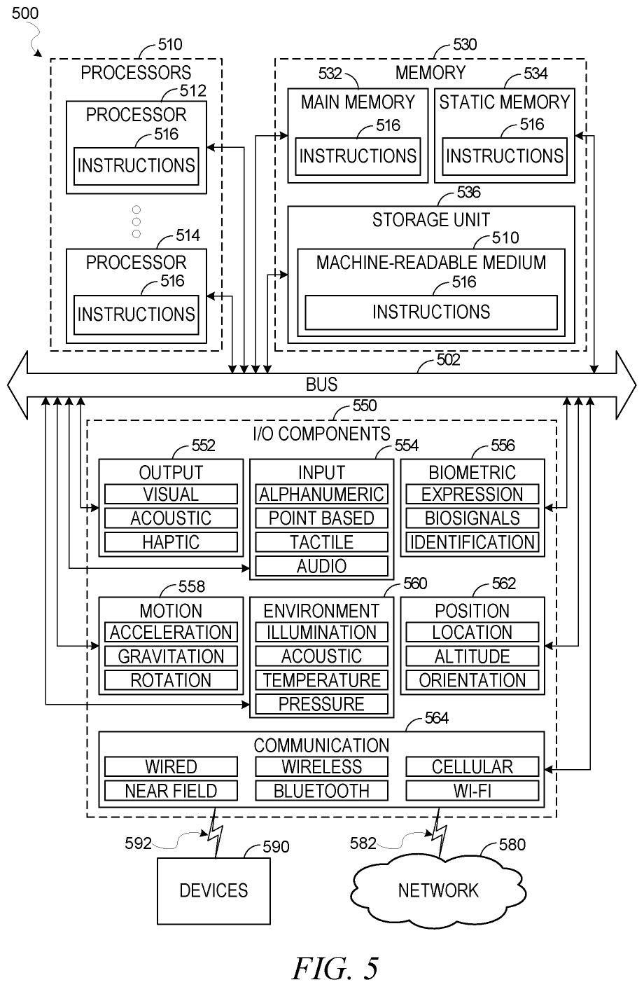

FIG. 4 is a block diagram 400 illustrating a software architecture 402, which can be installed on any one or more of the devices described above. FIG. 4 is merely a non-limiting example of a software architecture, and it will be appreciated that many other architectures can be implemented to facilitate the functionality described herein. In various embodiments, the software architecture 402 is implemented by hardware such as a machine 500 of FIG. 5 that includes processors 510, memory 530, and input/output (I/O) components 550. In this example architecture, the software architecture 402 can be conceptualized as a stack of layers where each layer may provide a particular functionality. For example, the software architecture 402 includes layers such as an operating system 404, libraries 406, frameworks 408, and applications 410. Operationally, the applications 410 invoke API calls 412 through the software stack and receive messages 414 in response to the API calls 412, consistent with some embodiments.

In various implementations, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking and security settings, among other functionalities. The services 422 can provide other common services for the other software layers. The drivers 424 are responsible for controlling or interfacing with the underlying hardware, according to some embodiments. For instance, the drivers 424 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410, according to some embodiments. For example, the frameworks 408 provide various graphical user interface functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications, such as a third-party application 466. According to some embodiments, the applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 illustrates a diagrammatic representation of a machine 500 in the form of a computer system within which a set of instructions may be executed for causing the machine 500 to perform any one or more of the methodologies discussed herein, according to an example embodiment. Specifically, FIG. 5 shows a diagrammatic representation of the machine 500 in the example form of a computer system, within which instructions 516 (e.g., software, a program, an application 410, an applet, an app, or other executable code) for causing the machine 500 to perform any one or more of the methodologies discussed herein may be executed. For example, the instructions 516 may cause the machine 500 to execute the method 300 of FIG. 3. Additionally, or alternatively, the instructions 516 may implement FIGS. 1-3, and so forth. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 512 and a processor 514 that may execute the instructions 516. The term “processor” is intended to include multi-core processors 510 that may comprise two or more independent processors 512 (sometimes referred to as “cores”) that may execute instructions 516 contemporaneously. Although FIG. 5 shows multiple processors 510, the machine 500 may include a single processor 512 with a single core, a single processor 512 with multiple cores (e.g., a multi-core processor), multiple processors 510 with a single core, multiple processors 510 with multiple cores, or any combination thereof.

The memory 530 may include a main memory 532, a static memory 534, and a storage unit 536, all accessible to the processors 510, such as via the bus 502. The main memory 532, the static memory 534, and the storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may include a wide variety of components to receive input, provide output, produce output, transmit information, exchange information, capture measurements, and so on. The specific I/O components 550 that are included in a particular machine 500 will depend on the type of machine 500. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion, and the grouping is in no way limiting. In various example embodiments, the I/O components 550 may include output components 552 and input components 554. The output components 552 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 590 via a coupling 582 and a coupling 592, respectively. For example, the communication components 564 may include a network interface component or another suitable device to interface with the network 580. In further examples, the communication components 564 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 590 may be another machine or any of a wide variety of peripheral devices (e.g., a peripheral device coupled via a USB).

Moreover, the communication components 564 may detect identifiers or include components operable to detect identifiers. For example, the communication components 564 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 530, 532, 534, and/or memory of the processor(s) 510) and/or the storage unit 536 may store one or more sets of instructions 516 and data structures (e.g., software) embodying or utilized by any one or more of the methodologies or functions described herein. These instructions (e.g., the instructions 516), when executed by the processor(s) 510, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 516 and/or data. The terms shall accordingly be taken to include, but not be limited to, solid-state memories, and optical and magnetic media, including memory internal or external to the processors 510. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 580 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 580 or a portion of the network 580 may include a wireless or cellular network, and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 592 (e.g., a peer-to-peer coupling) to the devices 590. The terms “transmission medium” and “signal medium” mean the same thing and may be used interchangeably in this disclosure. The terms “transmission medium” and “signal medium” shall be taken to include any intangible medium capable of storing, encoding, or carrying the instructions 516 for execution by the machine 500, and include digital or analog communication signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a processor; and
a computer-readable medium having instructions stored thereon, which, when executed by the processor, cause the system to perform operations comprising:
accessing a first set comprising pieces of content;
executing a machine learning relevance model to provide a score for each piece of content in the first set;
ranking pieces of content in the first set based on the scores;
accessing a two-sided diversity constraint, the two-sided diversity constraint having an upper bound and a lower bound for a first attribute of the pieces of content;
reducing the two-sided diversity constraint to a one-sided diversity constraint by eliminating either the upper bound or the lower bound;
adding a dual variable to the one-sided diversity constraint;
defining a dual objective function using the one-sided diversity constraint;
producing a solution to the dual objective function using a bisection method;
recovering a primal solution from the solution; and
re-ranking the pieces of content in the first set based on the primal solution;
causing display of one or more pieces of content in the first set based on the re-ranking.

2. The system of claim 1, wherein the bisection method iterates a plurality of times maintaining and updating an interval between a minimum value of the dual variable and a maximum value of the dual variable and shrinking the interval by half in each iteration.

3. The system of claim 2, wherein the solution is selected from the interval after at least 3 iterations.

4. The system of claim 3, wherein the operations further comprise screening out one or more pieces of content from the first set of pieces of content that would not be contained in a top n coordinates of a vector containing the solution, based on the scores.

5. The system of claim 1, wherein the machine learning relevance model is trained by passing training data through a machine learning algorithm.

6. The system of claim 5, wherein the machine learning algorithm is a neural network.

7. The system of claim 1, wherein the machine learning relevance model is retrained based on feedback from a viewer.

8. The system of claim 1, wherein the pieces of content are user profiles.

9. The system of claim 1, wherein the system is contained in a recommender, and the operations further comprise:
causing display of the re-ranked pieces of content in an electronic display as recommendations to a user operating a device containing or connected to the electronic display.

10. A computerized method comprising:
accessing a first set comprising pieces of content;
executing a machine learning relevance model to provide a score for each piece of content in the first set;
ranking pieces of content in the first set based on the scores;
accessing a two-sided diversity constraint, the two-sided diversity constraint having an upper bound and a lower bound for a first attribute of the pieces of content;
reducing the two-sided diversity constraint to a one-sided diversity constraint by eliminating either the upper bound or the lower bound;
adding a dual variable to the one-sided diversity constraint;
defining a dual objective function using the one-sided diversity constraint;
producing a solution to the dual objective function using a bisection method;
recovering a primal solution from the solution; and
re-ranking the pieces of content in the first set based on the primal solution;
causing display of one or more pieces of content in the first set based on the re-ranking.

11. The method of claim 10, wherein the bisection method iterates a plurality of time, maintaining and updating an interval between a minimum value of the dual variable and a maximum value of the dual variable, shrinking the interval by half in each iteration.

12. The method of claim 11, wherein the solution is selected from the interval after at least 3 iterations.

13. The method of claim 12, further comprising screening out one or more pieces of content from the first set of pieces of content that would not be contained in a top n coordinates of a vector containing the solution, based on the scores.

14. The method of claim 10, wherein the machine learning relevance model is trained by passing training data through a machine learning algorithm.

15. The method of claim 14, wherein the machine learning algorithm is a neural network.

16. The method of claim 10, wherein the machine learning relevance model is retrained based on feedback from a viewer.

17. The method of claim 10, wherein the pieces of content are user profiles.

18. The method of claim 10, wherein the method is run in a recommender, and the method further comprises:
causing display of the re-ranked pieces of content in an electronic display as recommendations to a user operating a device containing or connected to the electronic display.

19. A system comprising:
means for accessing a first set comprising pieces of content;
means for executing a machine learning relevance model to provide a score for each piece of content in the first set;
means for ranking pieces of content in the first set based on the scores;
means for accessing a two-sided diversity constraint, the two-sided diversity constraint having an upper bound and a lower bound for a first attribute of the pieces of content;
means for reducing the two-sided diversity constraint to a one-sided diversity constraint by eliminating either the upper bound or the lower bound;
means for adding a dual variable to the one-sided diversity constraint;
means for defining a dual objective function using the one-sided diversity constraint;
means for producing a solution to the dual objective function using a bisection method;
means for recovering a primal solution from the solution; and
means for re-ranking the pieces of content in the first set based on the primal solution;
means for causing display of one or more pieces of content in the first set based on the re-ranking.

20. The system of claim 19, wherein the bisection method iterates a plurality of time, maintaining and updating an interval between a minimum value of the dual variable and a maximum value of the dual variable, shrinking the interval by half in each iteration.
